(19) United States
(12) Patent Application Publication
(10) Pub. No.: US 2009/0255377 A1
(43) Pub. Date: Oct. 15, 2009

(54) Opener for bottles and the like

(76) Inventor: Katsumi Hasegawa, Seki-shi (JP)

Correspondence Address: JORDAN AND HAMBURG LLP, 122 EAST 42ND STREET, SUITE 4000, NEW YORK, NY, 10168, US

(21) Appl. No.: 12/383,629

(22) Filed: Mar. 26, 2009

(30) Foreign Application Priority Data
Apr. 14, 2008 (JP) 2008-104792

(51) Int. Cl. B67B 7/06

(52) U.S. Cl. 81/3.41

(57) ABSTRACT

Provided is an opener that allows for a smaller angle of aperture between the members when used, even with handle parts and trapping parts of the same size. Furthermore, the opener can be easily and reliably turned, so as to remove a cork or cap, with a hand covering the cork or cap. The opener comprises a pair of members; the members each having a handle part, a trapping part for trapping a cork or cap, and a hinge part; the trapping part is located between the handle part and the hinge part; the pair of members is hingeably coupled at the hinge parts so as to rotate around a hinge axis between an open position and a closed position; and the hinge parts project in the lengthwise directions of the members.

### TECHNICAL FIELD

The present invention relates to an opener for champagne bottles and other such bottles and the like.

### BACKGROUND ART

Tools exist for removing champagne corks (for example, see JP-2007-506622-A).

An object of the present invention is to provide an opener that allows for a smaller angle of aperture between the members when used, even with handle parts and trapping parts of the same size. Furthermore, an object is to provide an opener that can be easily and reliably turned, so as to remove a cork or cap, with a hand covering the cork or cap.

The opener in JP-2007-506622-A is such that a pair of jaws, which is to say, trapping parts, are directly coupled by a hinge, but the hinge part does not project from the jaws. Accordingly, the jaws must be opened wide in order to trap the cork. Consequently, the angle to which the members are opened is large, which makes the opener difficult to use, particularly for persons who have small hands, such as women and children.

Furthermore, if a campaign cork is not restrained, the cork will pop out, as can been seen in the victory ceremonies at car races. However, when bottles are opened indoors, it is dangerous for corks to fly out, and the preferred method of removing the cork is to remove it with as little noise as possible. Thus, in such situations, it is necessary to turn the opener with a hand covering the cork, so as to prevent the cork from flying out.

Accordingly, the present invention is directed at providing an opener that allows for a smaller angle of aperture between the members when used, even with handle parts and trapping parts of the same size.

Furthermore, the present invention is directed at providing an opener that can be reliably turned with a hand covering the cork, so that corks that are likely to fly out, such as champagne corks, can be prevented from flying out.

### DISCLOSURE OF THE INVENTION

The opener comprises a pair of members, the members each having a handle part, a trapping part for trapping a cork or cap, and a hinge part, the trapping part being located between the handle part and the hinge part, the pair of members being hingeably coupled at the hinge parts so as to rotate around a hinge axis between an open position and a closed position, and the hinge parts projecting in the lengthwise directions of the members.

In addition to the above, an element is added wherein the two hinge parts cooperate so as to constitute a finger grip part, this finger grip part extending sufficiently in the lengthwise direction of the members to allow gripping by a finger when the opener is used.

In addition, the thickness of the finger grip part, which is the thickness in the vertical direction when the opener is horizontally oriented, is no less than half the thickness of the trapping parts and no greater than twice the thickness of the trapping parts.

In addition, the thicknesses of the handle parts, the trapping parts and the finger grip part are substantially equal, and the outside faces thereof form arcuate convex faces having the same curvature.

In addition, the two handle parts extend rectilinearly, so that the two handle parts lay parallel alongside each other when the two members are closed, and a locking means, for preventing the two members from opening when the two members have been closed, is provided between the two handle parts.

In addition, at least two protrusions are provided on the inner face of at least one of the trapping parts, at least one of these two protrusions being provided at the center of the trapping part and the other protrusion being provided closer to the hinge part, the one protrusion protruding to a greater extent than the other protrusion.

### BRIEF DESCRIPTION OF THE DRAWINGS

FIG. 1 is a front view of the present invention.

FIG. 2 is a right side view of the present invention.

FIG. 3 is a sectional view according to line A-A in FIG. 1.

FIG. 4 is a perspective view of the present invention.

FIG. 5 is a front view of the present invention when opened.

FIG. 6 is a view showing the manner in which the present invention is used.

FIG. 7 is a sectional view showing the situation in which the members are locked.

FIG. 8 is a sectional view showing the situation in which the locking of the members is released.

FIG. 9 is a perspective view of a coil spring.

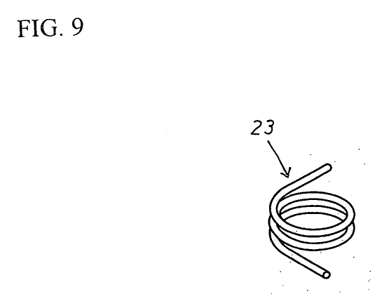

### DETAILED DESCRIPTION OF THE INVENTION

The opener comprises a pair of members, each of the members having a handle part, a trapping part and a hinge part, the pair of members being hingeably coupled by the hinge parts so as to rotate around a hinge axis between an open position and a closed position, and the hinge parts projecting in the lengthwise direction of the member. Thus, because the hinge axis is located on hinge parts that project in the lengthwise direction of the members, as differs from the conventional configuration in which the trapping parts were directly hingeably coupled, the hinge parts are located away from the trapping part. Consequently, if corks or caps of the same size are gripped with the trapping parts of the opener according to the present invention and with a conventional opener, the handles and the trapping parts of which are the same size, with the present invention, the angle of aperture of the members when used can be smaller than in the conventional case in which the trapping parts are directly hingeably coupled. Thus, because the members are not opened widely, operations are facilitated, and handling is easy. In particular, an opener can be provided that can easily be handled by women and children, who have small hands.

The two hinge parts cooperate to constitute a finger grip part, and this finger grip part projects in the lengthwise direction of the members, to a length that is sufficient for this to be gripped by a finger during use. That is to say, the two hinge parts can be used as a finger grip part. In this manner, for example when removing a champagne cork, when the opener is held with a hand around the trapping parts of the opener so that the hand covers the cork, the opener can be turned while gripping the finger grip part with a finger. Consequently, the opener can be easily and reliably turned. By turning the opener with the hand over the cork, it is possible to remove the cork while reliably preventing corks that are under pressure, such as champagne corks, from flying out.

The thickness of the finger grip part, which is to say, the thickness in the vertical direction when the opener is horizontally oriented, is no less than half the thickness of the trapping part and no greater than twice the thickness of the trapping part. If the finger grip part is thin, it is painful to turn the opener while gripping it with a finger. Furthermore, if there is a large difference between the thickness of the trapping part and the thickness of the finger grip part, the finger grip part is difficult to handle. Accordingly, if the thickness is no less than half the thickness of the trapping part and no greater than twice the thickness of the trapping part, there is no finger pain and handling is easy.

The thicknesses of the handle parts, the trapping parts and the finger grip part are substantially equal, and the outside faces thereof form arcuate convex faces having the same curvature. Because the outside faces form arcuate convex faces, the sectional shapes of the handle part and the trapping part are substantially semicylindrical. When holding the opener, this is held with the outside faces surrounded by the hand, and thus the arcuate convex outside faces fit into the rounded inner face of the hand, so that the opener is easy to hold. Accordingly, there is no risk of pain when turning the opener. Thus, all of the parts of the opener have substantially the same thickness and have arcuate convex faces with the same curvature. Accordingly, when the opener is held in the hand and turned, because this has the same arcuate convex faces, no matter which part of the opener is held, the user will not experience pain because the smooth convex faces will fit their hand. In particular, great force is applied to the finger that grips the finger grip part, but because the outside faces of the hinge parts have the same arcuate convex faces as the outside faces of the handle and the trapping part, this is notably not painful for the finger that grips the finger grip part.

The two handle parts extend rectilinearly, so that the two handle parts lay parallel alongside each other when the two members are closed, and a locking means, for preventing the two members from opening when the two members have been closed, is provided between the two handle parts. Because the two handle parts extend rectilinearly, and the two handle parts lay parallel alongside each other when the two members are closed, the two members can be closed with substantially no gap therebetween. Furthermore, because a locking means is provided between the two handle parts, the opener can be maintained compact when stored.

At least two protrusions are provided on the inner face of at least one of the trapping parts, at least one of these two protrusions being provided at the center of the trapping part and the other protrusion being provided closer to the hinge part, the one protrusion protruding to a greater extent than the other protrusion. Supposing that the central protrusion protruded by the same amount as the protrusion that is closer to the hinge part, when the cork was gripped so that the protrusions pressed into the cork, the protrusion that is closer to the hinge part would initially be pressed deeply into the cork, but because most protrusions are conical, it would not be pressed in further than this. Thus, the tip of the central protrusion would only be pressed in slightly, and insufficiently.

Because the central protrusion protrudes to a greater extent than the protrusion that is closer to the hinge, when the cork is gripped, the central protrusion can be sufficiently pressed into the cork, to the same extent as the protrusion that is closer to the hinge. Consequently, the cork can be reliably turned.

### BEST MODE FOR CARRYING OUT THE INVENTION

Next, modes of embodiments of the present invention will be described. In this mode of embodiment, an opener 1 serves to remove champagne corks. The opener 1 comprises a pair of elongate members 2, 3. The member 2 comprises a rectilinearly extending handle part 4, a trapping part 5, which is continuous with this handle part 4, and a hinge part 6, which is continuous with this trapping part 5. Furthermore, the member 3 likewise comprises a rectilinearly extending handle part 7, a trapping part 8, which is continuous with this handle part 7, and a hinge part 9, which is continuous with this trapping part 8. These members 2, 3 are made from aluminum, and are formed by die casting. However, materials other than aluminum may be used, and combinations of a plurality of materials may be used. For example, a grip made from a material that is different from the material used for the members 2, 3 may be provided on part of, or all of, the handle parts 4, 7. Examples of different materials that can be used include synthetic resins and wood.

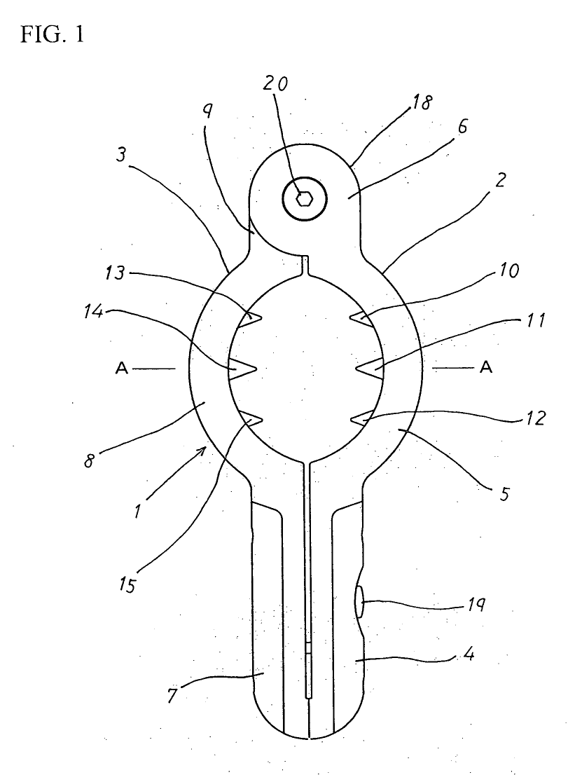

As shown in FIG. 1, the trapping parts 5, 8 of the two members 2, 3 are arcuately curved, so as to form circular arches. On each of the inner faces of the trapping parts 5, 8 are provided three protrusions 10, 11, 12, 13, 14, 15. The tips of these protrusions are sharply pointed and serve to press into the cork.

The protrusion 11, which is provided at the center of the trapping part 5, protrudes to a greater extent than the adjacent protrusions 10, 12. In a symmetrical manner, the protrusion 14, which is provided at the center of the trapping part 8, protrudes to a greater extent than the adjacent protrusions 13, 15. Here, a particularly significant aspect of the configuration is that the protrusions 11, 14, which are located at the centers of the two members 2, 3, are configured so as to protrude to a greater extent than the protrusions 10, 13, which are closer to the hinge parts 6, 9. Supposing that the central protrusions 11, 14 protruded to the same extent as the protrusions 10, 13 that are closer to the hinge, when the cork was gripped so that the protrusions are pressed into the cork, the protrusions that are closer to the hinge part would initially be pressed deeply into the cork, but because most protrusions are conical, they would not be pressed in further than this. Thus, the tips of the central protrusions 11, 14 would only be pressed in slightly and insufficiently. Consequently, most of the force with which the cork is rotated would be concentrated at the protrusions 10, 13 which are closer to the hinge part, and thus there would be a risk of damaging the cork into this area. In order to prevent this, the central protrusions 11, 14 protrude to a greater extent than the protrusions 10, 13 that are closer to the hinge parts 6, 9, whereby, when the cork is gripped, the central protrusions 11, 14 can be sufficiently pressed into the cork, to the same extent as the protrusions 10, 13, which are closer to the hinge part. Consequently, it is possible to reliably transmit force to the cork, so as to reliably rotate and remove the cork. However, the present invention is not limited to this configuration.

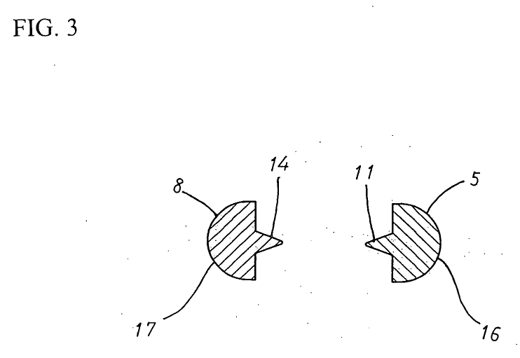

As shown in FIG. 3, the protrusions 11, 14 are formed integrally with the trapping parts 5, 8, respectively. All of the protrusions are formed integrally with the trapping parts on which they are provided. The outer faces 16, 17 of the trapping parts 5, 8 form respective arcuate convex faces. Because these form arcuate convex faces, the sectional shapes of the trapping parts 5, 8 are substantially semicylindrical. Because the outer faces of the trapping parts 5, 8 are formed in such a shape, when this part is held surrounded by the hand, these fit into the hand and can easily be held.

As shown in FIG. 1, the hinge parts 6, 9 of the two members 2, 3 are formed in a shape that is based on a substantially circular shape. The two hinge parts 6, 9 are overlaid and coupled by a hinge shaft 20. The two members 2, 3 open and close around a hinge axis, which is the centerline of this hinge shaft 20. As described above, the two hinge parts 6, 9 have a shape based on a substantially circular shape and therefore when the hinge part 6 and the hinge part 9 are rotated in opposite directions around the hinge shaft 20 so as to be mutually displaced, as when two circular plates are rotated in opposite directions around the same center of rotation, no portion of the hinge part 6 protrudes beyond the edge of the hinge part 9. Accordingly, if these rotated hinge parts 6, 9 are held or gripped with the fingers, it will not hurt. The overlaid hinge part 6 and hinge part 9 cooperate so as to function as a finger grip part 18.

The handle parts 4, 7 of the two members 2, 3 are formed so as to be substantially the same shape and substantially the same length. The two handle parts 4, 7 extend rectilinearly from the ends of the trapping parts 5, 8, respectively. As shown in FIG. 1, when the two members 2, 3 are closed, the two handle parts 4, 7 lay parallel alongside each other. As described below, a locking means is provided between the two handle parts 4, 7 so as to prevent the closed members 2, 3 from opening. Accordingly, the opener 1 can be maintained in a compact state when stored. Furthermore, this will not be bulky when carried in a pocket. As described below, a button 19, which is provided on the handle part 4, serves to release the locked state of the two handle parts 4, 7.

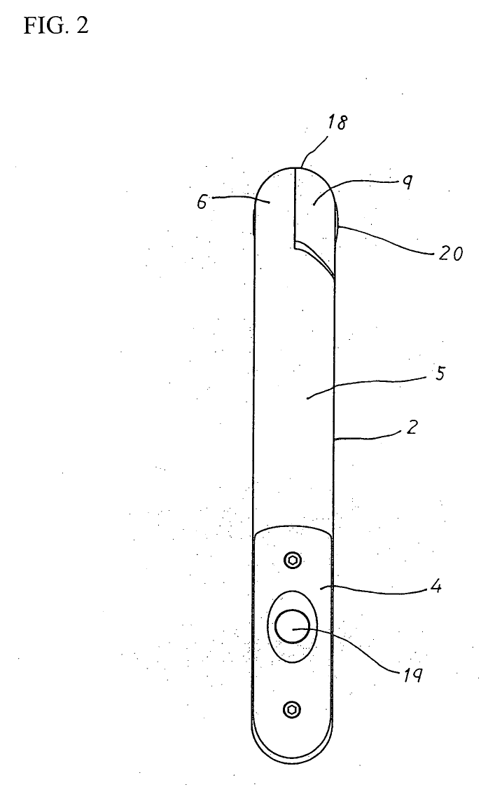

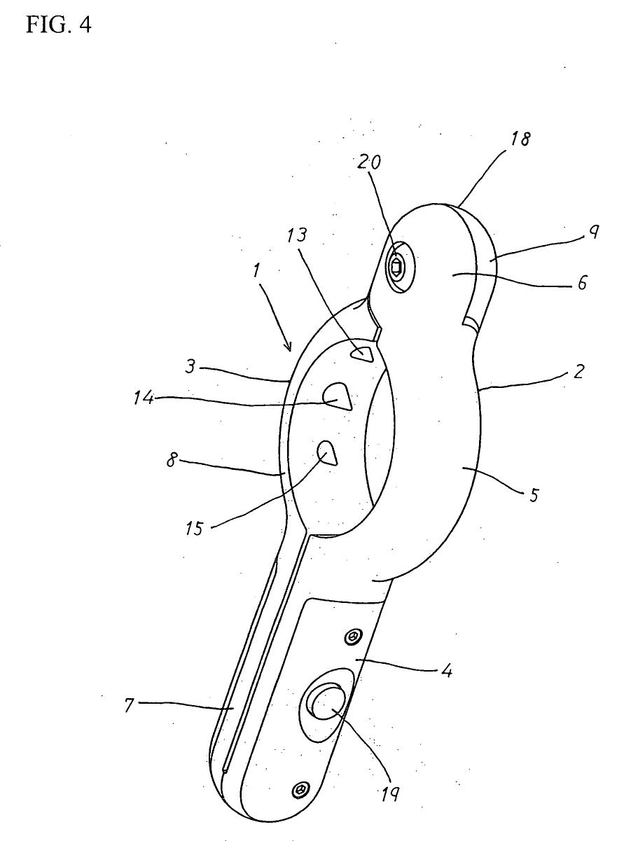

As shown in FIG. 2, the thicknesses of the handle part 4 and the trapping part 5, which is to say, the thicknesses in the crosswise direction in FIG. 2, are equal. Likewise, the thicknesses of the handle part 7 and the trapping part 8 are equal. Furthermore, the sectional shape of the handle part 4 is substantially the same as the sectional shape of the trapping part 5, and the sectional shape of the handle part 7 is substantially the same as the sectional shape of the trapping part 8. The thickness of the hinge part 6 of the member 2 is half of the thickness of the trapping part 5 and, in FIG. 2, the hinge part 6 is located on the left-hand side of the center line that extends in the lengthwise direction. Furthermore, the hinge part 9 of the member 3 is the same shape as the hinge part 6 and, in FIG. 2, this is located on the right-hand side of the center line that extends in the lengthwise direction. The two hinge parts 6, 9 are overlaid so as to constitute a finger grip part 18. The outside face of this finger grip part 18 forms an arcuate convex face having the same curvature as the two trapping parts 5, 8. Accordingly, when the two trapping parts 5, 8 are held in the hand, the finger grip part 18 can be gripped with the finger without discomfort. As shown in FIG. 4, because the outside of faces of the handle parts 4, 7, the trapping parts 5, 8 and the finger grip 18 of the opener 1 all form arcuate convex faces having the same curvature, the opener fits the hand without discomfort no matter where this is held by the hand or gripped by the fingers, so that the cork can be reliably turned. The finger grip part 18 is not limited to one wherein the two hinge parts 6, 9, which are present to the right and the left of the center line that extends in the lengthwise direction, are overlaid. For example, the configuration may be such that: the thickness of the hinge part 6 is half of the thickness of the trapping part 5; the hinge part 6 is provided at a position such that the centerline for the thickness of this hinge parts 6 coincides with the centerline for the thickness of the trapping part 5; the hinge part 9 is divided into two parts, the thickness of which are each one half of the thickness of the hinge part 6; and the hinge part 6 lies between the two parts of the divided hinge part 9.

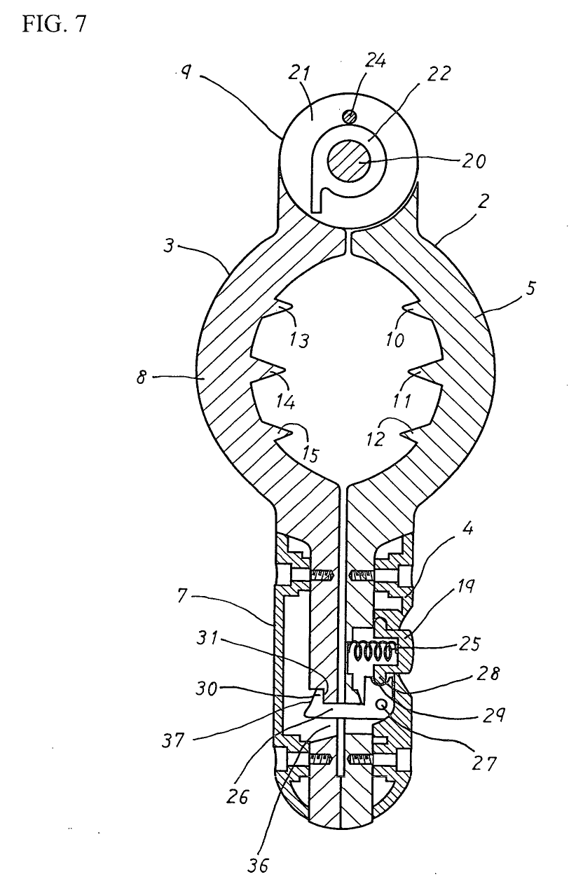

Next, the means for locking the members 2, 3 is described. FIG. 7 is a sectional view showing the situation in which the members 2, 3 are locked. Hatching has been omitted in some portions. An inner face 21 of the hinge part 9 of the member 3 forms a plane, in which a spring groove 22 is provided so as to surround the hinge shaft 20. A spring groove is also provided on an inner face (not shown) of the hinge part 6, which lies against the inner face 21 of the hinge part 9. By fitting a coil spring 23 into these two spring grooves, the members 2, 3 are urged in the opening direction by the elastic force of the coil spring 23. Furthermore, a limiting protrusion 24 is provided on the inner face 21 of the member 3, so as to limit excessive opening of the members 2, 3. Furthermore, a guide groove (not shown) for the limiting protrusion 24 is provided on the inner face of the member 2. The members 2, 3 open and close with the limiting protrusion 24 traveling in the guide groove. When the members 2, 3 are opened as far as a predetermined angle, the limiting protrusion 24 strikes the end of the guide groove, and thus the members 2, 3 are limited from opening beyond this angle. In terms of the predetermined angle, an angle of approximately 30° to 45° is preferred.

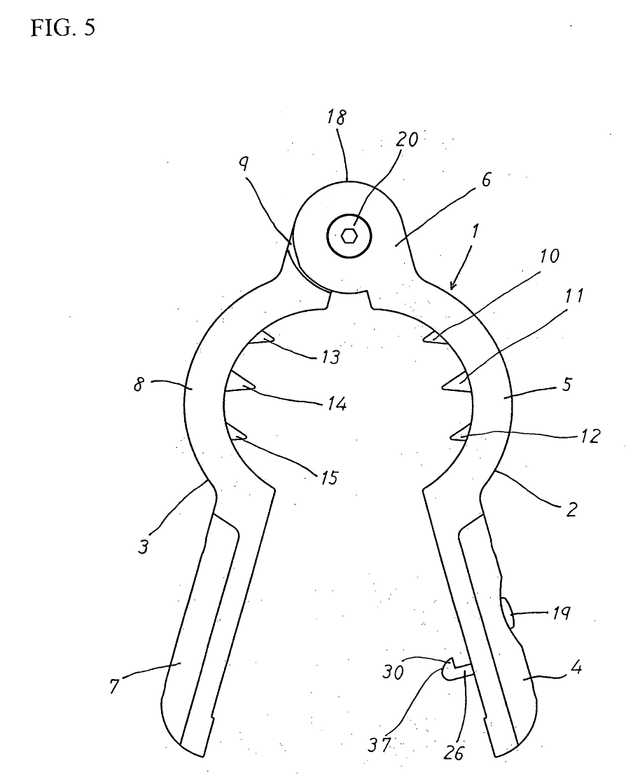

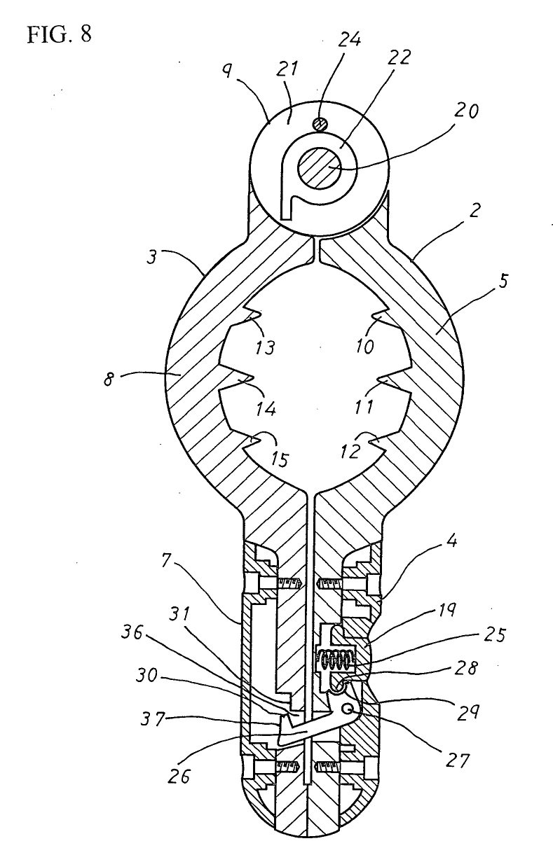

As shown in FIG. 7, a button 19, which is mounted on the member 2, is urged in the direction of the surface thereof by a coil spring 25. Furthermore, a hook 26 is mounted on the member 2, so as to be rotatable around a pivot 27. Furthermore, a projection 30, which is provided at the end of the hook 26, engages in a pressure contact manner with a locking part 31 on the member 3, so as to lock the members 2, 3 from opening by way of the elastic force of the coil spring 25. To release the lock, the button 19 is pushed down. As shown in FIG. 8, when the button 19 is depressed, a projection 28 presses against a receiving part 29 in the hook 26, so that the hook 26 rotates anticlockwise around the pivot 27. As a result of the rotation of the hook 26, the projection 30 on the hook 26 rotates anticlockwise around the pivot 27, and disengages from the locking part 31, releasing the lock. When the lock is released, the projection 30 escapes from a hole 36, as a result of the elastic force of the coil spring 23, and the members 2, 3 open naturally. To lock the opener once again after the members 2, 3 have opened as shown in FIG. 5, as a result of holding the opener in one hand and closing the members 2, 3 together, an inclined face 37, which is formed at the end of the projection 30, strikes against the edge of the hole 36, automatically rotating the hook 26, so that the protrusion 30 is inserted into the hole 36, and the opener is automatically locked. Furthermore, the spring constant of the coil spring 23, which urges the members 2, 3 in the opening direction is greater than the spring constant of the coil spring 25, which supports the button 19. Accordingly, in order to open the members 2, 3, which have been closed, the members 2, 3 are held in one hand, and the button 19 is pressed, whereupon, because the spring constant of the coil spring 23 is greater, if the button 19 is maintained depressed, the members 2, 3 will automatically open. Thus, the members 2, 3 can be opened and closed with one hand. As shown in FIG. 1, when the members 2, 3 are closed, the handle parts 4, 7 lay parallel alongside each other and the hook 26 is hidden by the handle parts 4, 7, resulting in a good appearance.

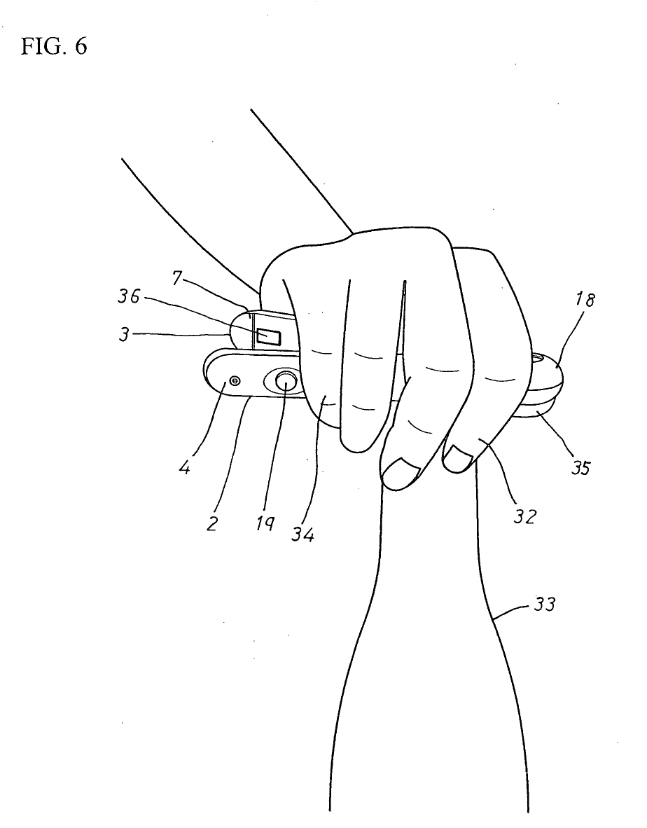

Next, a method of using the present invention is described. Normally, a champagne cork is covered with a wire in order to prevent it from flying out, and therefore, before the cork is taken out, the wire is removed. Next, the cork is trapped by the trapping parts 5, 8. At this time, the cork can be prevented from accidentally flying out by pressing the top of the cork with a hand, while trapping the cork. Next, the handle parts 4, 7 are held so as to apply force in the direction that closes the members 2, 3, so as to press the protrusions 10 to 15 into the cork. Next, as shown in FIG. 6, the trapping parts 5, 8 are held so as to be surrounded by the hand, with a hand covering the cork, and the index finger 32 grips the finger grip part 18. Furthermore, the ball of the thumb 35 grips the finger grip part 18. Consequently, the finger grip part 18 is gripped from both sides by the index finger 32 and the ball of the thumb 35. Furthermore, preferably, at least the little finger 34 grips the handle part 4.

Next, the bottom of the bottle 33 is gripped by a hand, and the hand that is holding the opener 1 rotates the opener 1 to the right and the left, a little bit at a time. At this point, if the opener 1 is rotated clockwise, by applying force to the trapping parts 5, 8 and the handle parts 4, 7 with the hand, while applying force to the finger grip part 18 with the ball of the thumb 35, smooth and reliable rotation is possible. Furthermore, at this point, if the opener 1 is rotated anticlockwise, by applying force to the trapping parts 5, 8 and the handle parts 4, 7 with the hand, while applying force to the finger grip part 18 with the index finger 32, smooth and reliable rotation is possible. If the rotation is repeated several times while pulling up on the cork little by little, the cork begins to come out, as a result of the pressure of the carbon dioxide gas within the bottle 33, and thus the cork is gradually removed while being restrained with the hand. Lastly, because it is desirable that the cork be removed with as little noise as possible, the cork is removed by way of gradually releasing the pressure within the bottle 33 by inclining the cork. At this point, because the operator has covered the cork with a hand from the beginning, the cork can be restrained, which prevents the cork from flying out during these operations. In the foregoing, a method was described in which the opener 1 was rotated with the bottle 33 held in place, but the cork can be removed by rotating the bottle 33 with the opener 1 held in place.

Next, the sizes in this mode of embodiment of the present invention are described. The overall length of the opener 1 is 110 mm; the length of the trapping part 5 or the trapping part 8, as measured in the lengthwise direction, is approximately 40 mm; and the length of the handle part 4 or the handle part 7 is approximately 50 mm. The finger grip part 18 projects from the trapping parts 5, 8 by approximately 20 mm. The total length of the trapping part 5 or the trapping part 8 and the finger grip part 18 is approximately 60 mm, with the handle part 4 or the handle part 7 being shorter than this. Accordingly, when the opener 1 is used, if the trapping parts 5, 8 are held in the hand and rotated, the handle parts 4, 7 do not greatly protrude from the hand, and therefore are not in the way. Furthermore, when the members 2, 3 are locked, the maximum width at the trapping parts 5, 8 is approximately 40 mm. Furthermore, the thickness of the opener 1 is approximately 14 mm, which is the same at the handle parts, the trapping parts and the finger grip part. Preferably, the handle parts 4, 7 and the trapping parts 5, 8 are of a size whereby these can be enclosed by the palm of the hand with the cork trapped. Furthermore, the diameter of the arch shaped portion of the sections of the trapping parts 5, 8 which form arcuate convex surfaces is approximately 7 mm. However, it is a matter of course that the present invention is not limited to the values mentioned above.

What I claim is:

1. An opener for bottles and the like comprising a pair of members, the members each having a handle part, a trapping part for trapping a cork or cap, and a hinge part, the trapping part being located between the handle part and the hinge part, said pair of members being hingeably coupled at the hinge parts so as to rotate around a hinge axis between an open position and a closed position, and said hinge parts projecting in the lengthwise directions of the members.

2. The opener recited in claim 1, wherein the two hinge parts cooperate so as to constitute a finger grip part, said finger grip part extending sufficiently in the lengthwise direction of the members to allow gripping by a finger when the opener is used.

3. The opener recited in claim 2, wherein the thickness of the finger grip part, which is the thickness in the vertical direction when the opener is horizontally oriented, is no less than one half the thickness of the trapping parts and no greater than twice the thickness of the trapping parts.

4. The opener recited in claim 2 or claim 3, wherein the thicknesses of the handle parts, the trapping parts and the finger grip part are substantially equal, and the outside faces thereof form arcuate convex faces having the same curvature.

5. The opener recited in any one of claims 1 to 3, wherein the two handle parts extend rectilinearly, so that the two handle parts lay parallel alongside each other when the two members are closed, and a locking means, for preventing the two members from opening when the two members have been closed, is provided between the two handle parts.

6. The opener recited in any one of claims 1 to 3, wherein at least two protrusions are provided on the inner face of at least one of the trapping parts, at least one of these two protrusions being provided at the center of the trapping part and the other protrusion being provided closer to the hinge part, said one protrusion protruding to a greater extent than said other protrusion.

7. The opener recited in claim 4, wherein the two handle parts extend rectilinearly, so that the two handle parts lay parallel alongside each other when the two members are closed, and a locking means, for preventing the two members from opening when the two members have been closed, is provided between the two handle parts.

8. The opener recited in claim 4, wherein at least two protrusions are provided on the inner face of at least one of the trapping parts, at least one of these two protrusions being provided at the center of the trapping part and the other protrusion being provided closer to the hinge part, said one protrusion protruding to a greater extent than said other protrusion.

9. The opener recited in claim 4, wherein the two handle parts extend rectilinearly, so that the two handle parts lay parallel alongside each other when the two members are closed, and a locking means, for preventing the two members from opening when the two members have been closed, is provided between the two handle parts, and wherein at least two protrusions are provided on the inner face of at least one of the trapping parts, at least one of these two protrusions being provided at the center of the trapping part and the other protrusion being provided closer to the hinge part, said one protrusion protruding to a greater extent than said other protrusion.

10. An opener for a container having a closure element, comprising a pair of members each having a handle part, a trapping part for trapping the closure element, and hinge parts, the trapping part being located between the handle part and the hinge parts, said pair of members being hingeably coupled at the hinge parts so as to rotate around a hinge axis between an open position and a closed position, said hinge parts projecting in the lengthwise directions of the members.
